(19) United States
(12) Patent Application Publication
(10) Pub. No.: US 2017/0048312 A1
(43) Pub. Date: Feb. 16, 2017

(54) SDN-BASED MIRRORING OF TRAFFIC FLOWS FOR IN-BAND NETWORK ANALYTICS

(71) Applicant: Brocade Communications Systems, Inc., San Jose, CA (US)

(72) Inventor: Peter J. Moyer, Fremont, CA (US)

(21) Appl. No.: 14/918,441

(22) Filed: Oct. 20, 2015

Related U.S. Application Data
(60) Provisional application No. 62/204,388, filed on Aug. 12, 2015.

(51) Int. Cl. H04L 29/08; H04L 12/26

(52) U.S. Cl. CPC H04L 67/1095; H04L 43/04; H04L 43/12

(57) ABSTRACT

Techniques for performing SDN-based mirroring of traffic flows for in-band network analytics are provided. In one embodiment, a computer system can receive minoring configuration information from an agent, where the minoring configuration information includes one or more parameters specifying a flow to be mirrored by an in-band network device of a network and one or more parameters specifying a mirror port of the in-band network device. The computer system can further generate a mirroring command based on the minoring configuration information, where the mirroring command includes a rule indicating the in-band network device should minor the flow to the mirror port concurrently with Layer 2 or 3 forwarding of the flow within the network. The computer system can then transmit the minoring command to the in-band network device.

### CROSS-REFERENCES TO RELATED APPLICATIONS

The present application claims the benefit and priority under U.S.C. 119(e) of U.S. Provisional Application No. 62/204,388, filed Aug. 12, 2015, entitled “SDN-BASED MIRRORING OF TRAFFIC FLOWS FOR IN-BAND NETWORK ANALYTICS.” The entire contents of this provisional application are incorporated herein by reference for all purposes.

### BACKGROUND

Network analytics refers to the practice of gathering information, such as data plane traffic, from a network while it is in operation and analyzing the gathered information for various purposes (e.g., reporting, network troubleshooting, threat detection, etc.). There are generally two types of approaches for gathering data plane traffic in a network analytics solution: the in-band approach and the out-of-band approach.

With the in-band approach, one or more network devices that are responsible for forwarding live data plane traffic in the network (e.g., production switches and/or routers) are also configured to minor that traffic to one or more analytics tools. Unfortunately, existing in-band traffic gathering mechanisms rely on conventional port minoring (e.g., SPAN/RSPAN or ACL-based), which suffers from a number of drawbacks. First, port mirroring can be inefficient because it requires all traffic received on an ingress port of a network device to be copied to the minor port, even though only a portion of the ingress port's traffic may be of interest to the analytics tools. As a result, additional functionality (such as a packet broker) is needed in order to filter/sort through the mirrored traffic and to find the particular traffic types that are the subject of analysis. Second, port minoring cannot be dynamically configured on a network device; instead, an operator needs to configure port minoring manually on the device via a command line interface (CLI) and make manual changes to that configuration as needed. Third, existing switches/routers generally have various and different limitations with respect to SPAN/RSPAN-based port minoring support.

With the out-of-band approach, data plane traffic is tapped from the network being monitored/analyzed and sent to one or more “visibility” or “telemetry” switches. These visibility/telemetry switches are separate network devices that are dedicated to the tasks of filtering, aggregating, and forwarding the tapped traffic to analytics tools; thus they are considered “out-of-band” with respect to the monitored network. While this approach can be more flexible than the in-band approach, it also suffers from certain drawbacks. For example, out-of-band data gathering can significantly increase the capital and operational costs of a network deployment due to the need to acquire and deploy the dedicated visibility/telemetry switches, which are separate from the in-band switches/routers of the network. Further, the out-of-band approach still requires manual configuration of each visibility/telemetry switch in order to perform appropriate filtering, aggregation, and forwarding of tapped traffic to the analytics tools.

### SUMMARY

Techniques for performing SDN-based minoring of traffic flows for in-band network analytics are provided. In one embodiment, a computer system can receive mirroring configuration information from an agent, where the minoring configuration information includes one or more parameters specifying a flow to be mirrored by an in-band network device of a network and one or more parameters specifying a mirror port of the in-band network device. The computer system can further generate a mirroring command based on the minoring configuration information, where the mirroring command includes a rule indicating the in-band network device should minor the flow to the mirror port concurrently with Layer 2 or 3 forwarding of the flow within the network. The computer system can then transmit the minoring command to the in-band network device.

The following detailed description and accompanying drawings provide a better understanding of the nature and advantages of particular embodiments.

### BRIEF DESCRIPTION OF DRAWINGS

FIG. 1 depicts a system environment comprising an SDN application for enabling SDN-based mirroring of traffic flows according to an embodiment.

FIG. 2 depicts a minoring workflow within the system environment of FIG. 1 according to an embodiment.

FIG. 3 depicts a flowchart performed by the SDN application of FIG. 1 according to an embodiment.

FIG. 4 depicts a remote mirroring workflow within the system environment of FIG. 1 according to an embodiment.

FIG. 5 depicts a network switch/router according to an embodiment.

FIG. 6 depicts a computer system according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

### 1. Overview

The present disclosure describes techniques that leverage SDN to enable in-band minoring of traffic flows for network analytics. In one set of embodiments, these techniques involve implementing an SDN application that can receive mirroring configuration information from an agent (e.g., a user or another application), where the mirroring configuration information includes parameters specifying (1) a traffic flow (also referred to as a “network flow” or “flow”) to be mirrored, and (2) an egress (mirror) port of an in-band network device in the network for sending out the mirrored traffic. As used herein, an “in-band network device” is a device that is involved in forwarding live data plane traffic within the network, such as a production switch or router. The SDN application can then transmit, via an appropriate southbound SDN protocol such as OpenFlow, a mirroring command to the in-band network device based on the flow and minor port parameters included in the mirroring configuration information.

Upon receiving the mirroring command, an SDN component running on the in-band network device can process the command and, based on that processing, configure/program the in-band network device to minor the specified flow to the specified mirror port. In certain embodiments, the minoring command can include a specific type of rule (e.g., a “mirror+normal” action) that causes the in-band network device to perform the flow minoring concurrently with, rather than in lieu of, its normal forwarding/routing of the flow. Accordingly, in these embodiments, minoring can be achieved without interrupting or impeding the in-band network device's normal Layer 2/3 operation.

The techniques of the present disclosure provide a number of benefits over existing data gathering approaches for network analytics. First, since these techniques allow for per-flow minoring, they offer greater data granularity and thus better efficiency than mechanisms that rely on traditional port mirroring. For instance, these techniques can enable mirroring of a subset of the traffic received on an ingress port that corresponds to a particular flow, rather than mirroring all of the traffic received on that port.

Second, because the techniques of the present disclosure make use of the existing, in-band network devices in a network, they avoid the high costs of out-of-band data gathering mechanisms that require the procurement and deployment of dedicated visibility/telemetry switches.

Third, the SDN application described above advantageously provides a centralized point of management for configuring mirroring on multiple (and potentially all) network devices in a network. As a result, the use of this application can significantly reduce the administrative burden on network administrators and users, who would otherwise need to manually configure each network device (via, e.g., a device-specific CLI or other interface) on which mirroring is desired.

The foregoing and other aspects of the present disclosure are described in further detail in the sections that follow.

### 2. System Environment

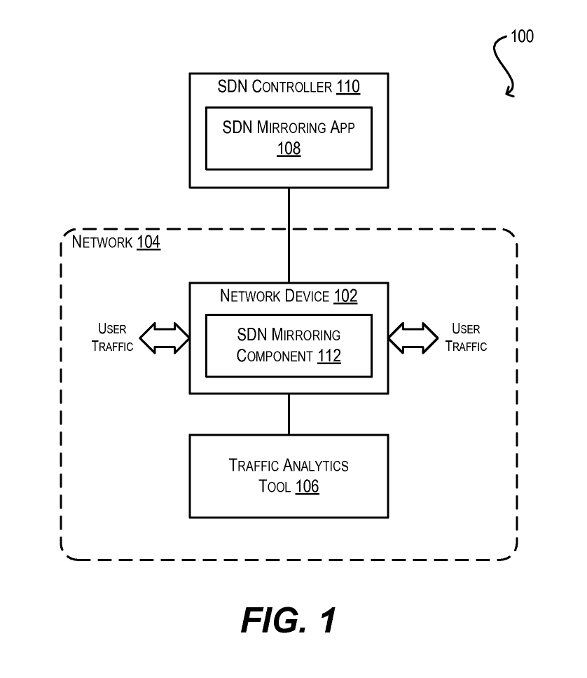

FIG. 1 depicts a system environment 100 that supports SDN-based mirroring of traffic flows for in-band network analytics according to an embodiment. As shown, system environment 100 includes a network device 102 that is responsible for forwarding live data plane (i.e., user) traffic within a network 104. In other words, network device 102 is an in-band device that is configured to perform normal IPv4/IPv6/MPLS packet forwarding in network 104. In one embodiment, network device 102 can be a physical, hardware-based device, such as a hardware-based switch or router. In another embodiment, network device 102 can be a virtual device, such as a virtual switch/router.

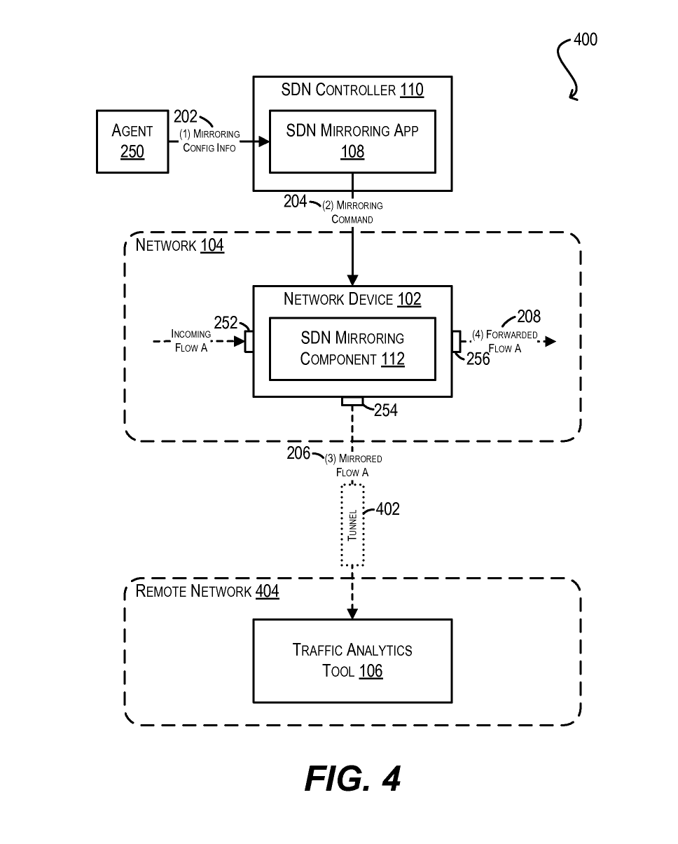

System environment 100 further includes a traffic analytics tool 106 that is operable to receive mirrored network traffic from, e.g., network device 102 and/or other sources, and to analyze the mirrored traffic for various purposes, such as reporting, network troubleshooting, and so on. In the example of FIG. 1, traffic analytics tool 106 is shown as being part of the same network 104 as network device 102. However, in alternative embodiments, traffic analytics tool 106 may reside in a separate, remote network (discussed with respect to FIG. 4 below).

As noted in the Background section, existing approaches for gathering data plane traffic for consumption by traffic analytics tools such as tool 106 of FIG. 1 generally suffer from a number of limitations. For instance, in-band approaches that rely on conventional port minoring can be inefficient and difficult for administrators to manage/configure. Further, out-of-band approaches that rely on dedicated visibility/telemetry switches (separate from in-band network device 102) can significantly increase the capital and operational costs of a network deployment.

To address these and other similar issues, system environment 100 of FIG. 1 includes a novel SDN minoring application 108 that runs on an SDN controller 110, and a novel SDN minoring component 112 that runs on network device 102. SDN controller 110 can be implemented using a general purpose computer system and can correspond to any proprietary or open-source SDN controller known in the art, such as the OpenDaylight controller, the Brocade Vyatta controller, or the like. As explained in further detail below, SDN mirroring application 108 can receive configuration information for enabling minoring of a particular network flow on network device 102 to traffic analytics tool 106, and can send a mirroring command to network device 102 based on this configuration information. In response, SDN component 112 of network device 102 can process the minoring command and can program the device to mirror the network flow as specified in the command, in addition to performing its normal forwarding of the flow within network 104. In this way, application 108 and SDN component 112 can cooperate to enable dynamic, per-flow mirroring that is carried out in-band on network device 102, without adversely affecting the device's normal Layer 2/3 functionality.

It should be appreciated that system environment 100 of FIG. 1 is illustrative and not intended to limit embodiments of the present disclosure. For example, although only a single traffic analytics tool is shown, in certain embodiments system environment 100 may include multiple analytic tools that are each configured to receive/analyze a subset of the traffic mirrored from network device 102 and/or other sources. Further, the various components shown in FIG. 1 may have sub-components or functions that are not specifically described, or may be arranged according to different configurations/arrangements. One of ordinary skill in the art will recognize other modifications, variations, and alternatives.

### 3. Minoring Workflow

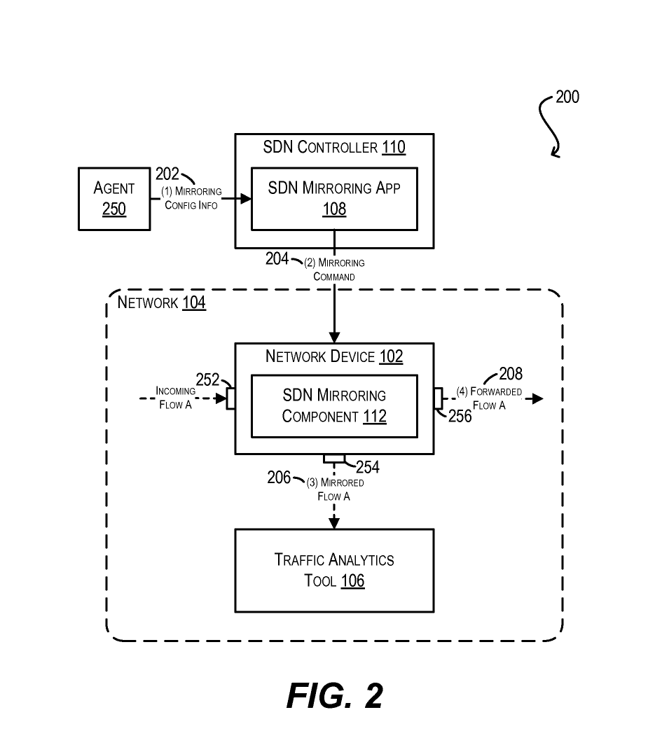

FIG. 2 depicts a high-level workflow 200 that can be carried out by SDN minoring application 108 and SDN mirroring component 112 of FIG. 1 for enabling in-band mirroring of traffic flows according to an embodiment.

Starting with step (1) (reference numeral 202), SDN minoring application 108 can receive mirroring configuration information from an agent 250 that includes parameters specifying a flow to be mirrored on network device 102 and an egress (i.e., minor) port of device 102 for sending the mirrored traffic to a traffic analytics tool (e.g., tool 106). For instance, the minoring configuration information can include parameters specifying (1) a source IP address, a destination IP address, a source port, a destination port, and/or a Layer 4 protocol (e.g., TCP, UDP, etc.) for the flow, and (2) a port number for the mirror port. In the example of FIG. 2, the flow to be mirrored is assumed to be a “flow A” that is received on an ingress port 252 of network device 102, and the desired minor port is assumed to be an egress port 254 of network device 102 that leads to traffic analytics tool 106.

In certain embodiments, agent 250 can be an individual, such as a network administrator or user. In these embodiments, agent 250 can provide the mirroring configuration information to SDN mirroring application 108 via a user interface that is made available by application 108. In other embodiments, agent 250 can be another software application, such as a traffic analytics application that is in communication with traffic analytics tool 106. In these latter embodiments, agent 250 can automatically determine which flow(s) should be mirrored based on, e.g., the analyses performed by tool 106, and can invoke one or more application programming interfaces (APIs) exposed by SDN mirroring application 108 in order to communicate the minoring configuration information to application 108.

At step (2) (reference numeral 204), SDN minoring application 108 can determine a minoring command based on the flow/mirror port parameters received from agent 250 and can transmit the minoring command to network device 102. In various embodiments, the minoring command can be formatted according to a southbound SDN protocol that is understood by SDN minoring component 112 of network device 102. For example, in scenarios where SDN minoring component 112 understands the OpenFlow protocol, the minoring command can be an OpenFlow command. Further, in a particular embodiment, the minoring command can include a rule or action that indicates the flow minoring should be performed concurrently with, rather than in lieu of, network device 102's normal Layer 2/3 forwarding. For instance, in the case of OpenFlow, the mirroring command can comprise a new “mirror +normal” rule/action.

Upon receiving the mirroring command, SDN minoring component 112 can process the command and, based on the included parameters/rule(s), program network device 102 to minor incoming traffic for the specified flow to the specified mirror port. For instance, in the example of FIG. 2, the processing of this mirroring command by SDN mirroring component 112 causes network device 102 to mirror incoming traffic for flow A to mirror port 254 (step (3), reference numeral 206).

At the same time, due the “minor +normal” action included in the mirroring command, network device 102 can continue to perform its normal Layer 2/3 forwarding of flow A by sending the flow to an appropriate egress port of the device (e.g., port 256, shown at step (4), reference numeral 208). In certain embodiments, in order to support this concurrent minoring+normal forwarding of flow A, ingress port 254 can be specifically configured to operate in a “hybrid mode” which enables the port to act upon both programmed SDN rules (like the minoring command received from SDN mirroring application 108) and device 102's normal hardware forwarding table(s). An example of such a hybrid mode is the OpenFlow Hybrid Port Mode supported by switches and routers from Brocade Communications Systems, Inc.

Finally, although not shown in FIG. 2, network device 102 can continue minoring and forwarding flow A until device 102 receives a second command from application 108 to stop its minoring. This second command may be issued in response to, e.g., input from agent 250 indicating that the minoring of flow A to traffic analytics tool 106 is no longer needed. Upon receiving this second command, SDN mirroring component 112 of network device 102 can reprogram the device to carry out its normal forwarding of flow A to egress port 256, without performing any further copying of the flow traffic to mirror port 254.

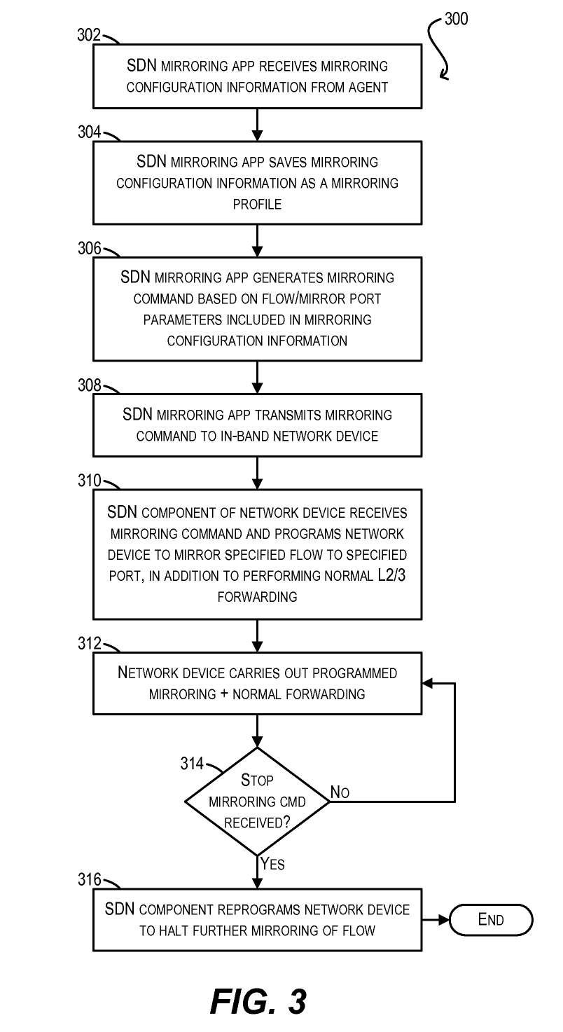

FIG. 3 depicts, in the form of a flowchart 300, additional details regarding the processing attributed to SDN minoring application 108 and SDN mirroring component 112 in workflow 200 according to an embodiment. At block 302, SDN minoring application 108 can first receive mirroring configuration information from agent 250. As mentioned previously, this minoring configuration information can include parameters specifying a flow to be mirrored on an in-band network device (e.g., device 102), as well as a minor port on the device for sending the mirrored traffic to a traffic analytics tool (e.g., tool 106).

At blocks 304 and 306, SDN mirroring application 108 can save the received mirroring configuration information as a minoring profile and can generate a minoring command based on the specified flow/mirror port parameters. The mirroring command can include a rule/action indicating that the minoring of the flow to the minor port should be performed concurrently with network device 102's normal Layer 2/3 forwarding. As part of block 306, SDN mirroring application 108 can determine an appropriate southbound protocol that is understood by network device 102 and can generate the minoring command in accordance with that protocol. SDN mirroring application 108 can then transmit the mirroring command to network device 102 (block 308).

At block 310, SDN minoring component 112 of network device 102 can receive the mirroring command and can program network device 102 to mirror the specified flow to the specified mirror port, in addition to performing its normal Layer 2/3 forwarding of the flow. In a particular embodiment, this programming can include, e.g., installing one or more entries in an SDN flow table of network device 102 that instructs the device to minor the flow in accordance with the parameters/rule(s) included in the mirroring command, as well as configuring the ingress port(s) of the network device 102 to operate in hybrid mode (if they are not already configured as such).

Then, at block 312, network device 102 can carry out the programmed mirroring +forwarding of the flow. For example, upon receiving an incoming packet, network device 102 can first attempt to match the packet against its SDN flow table to see whether it is part of the flow to be mirrored. If so, network device 102 can copy the packet to the specified minor port. Network device 102 can subsequently pass the packet through its normal forwarding pipeline so that it can be forwarded per the device's standard Layer 2/3 functionality.

If, at some point, network device 102 receives a “stop minoring” command for the flow from SDN minoring application 108, SDN mirroring component 112 can reprogram the device to suspend any further minoring (by, e.g., removing the previously added entries in the flow table) and flowchart 300 can end (blocks 314 and 316). This may occur if, e.g., agent 250 disables or deletes the mirroring profile saved at block 304. Otherwise, network device 102 can continue its mirroring +forwarding until the “stop minoring” command is received or the device is reset.

### 4. Remote Minoring Use Case

In some embodiments, traffic analytics tool 106 may reside in a separate, remote network rather than the same network as network device 102. In these embodiments, rather than directly transmitting the mirrored traffic to traffic analytics tool 106, network device 102 can encapsulate the mirrored traffic according to an appropriate tunneling protocol (e.g., VXLAN, GRE, etc.) and can send out the encapsulated traffic via the tunneling protocol to tool 106 in the remote network. An example of such a workflow 400 is shown in FIG. 4, which is substantially similar to workflow 200 of FIG. 2 but illustrates the mirrored traffic for flow A as being sent via tunnel 402 to remote network 404.

To enable this tunneling, in one embodiment the minoring configuration information received by SDN mirroring application 108 from agent 250 can include information regarding how the mirrored flow should be tunneled (e.g., tunneling protocol, address of remote tool, etc.). SDN mirroring component 112 can then generate and send one or more commands to network device 102 for dynamically establishing a tunnel to the analytics tool, prior to initiating the minoring. Alternatively, a network administrator/user can manually configure a logical tunnel interface on network device 102, which agent 250 can specify as the mirror port as part of the minoring configuration information.

### 5. Network Switch/Router

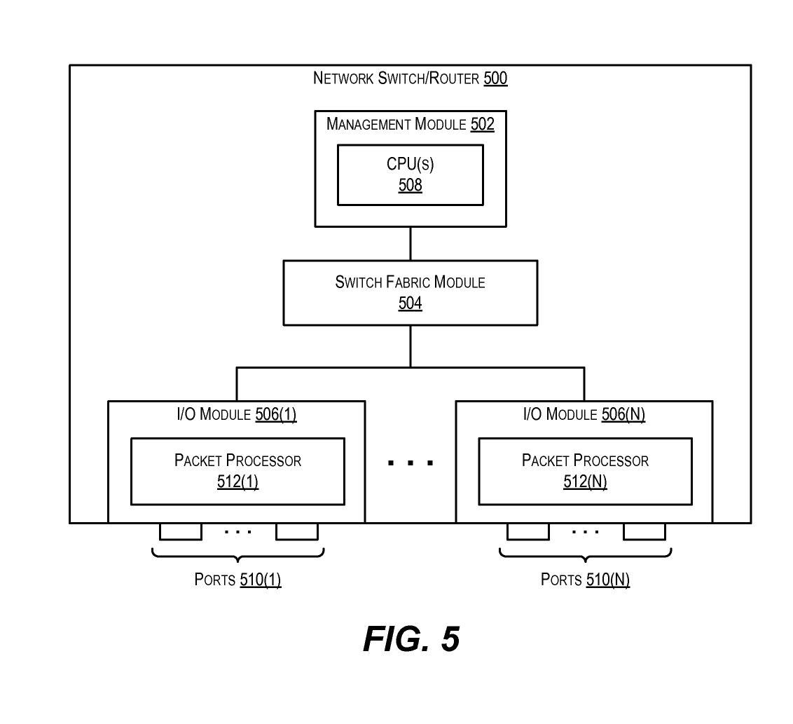

FIG. 5 depicts an example network switch/router 500 that may be used to implement network device 102 of FIGS. 1, 2, and 4 according to an embodiment.

As shown, network switch/router 500 includes a management module 502, a switch fabric module 504, and a number of I/O modules 506(1)-506(N). Management module 502 represents the control plane of network switch/router 500 and thus includes one or more management CPUs 508 for managing/controlling the operation of the device. Each management CPU 508 can be a general purpose processor, such as a PowerPC, Intel, AMD, or ARM-based processor, that operates under the control of software stored in an associated memory (not shown).

Switch fabric module 504 and I/O modules 506(1)-506(N) collectively represent the data, or forwarding, plane of network switch/router 500. Switch fabric module 504 is configured to interconnect the various other modules of network switch/router 500. Each I/O module 506(1)-506(N) can include one or more input/output ports 510(1)-510(N) that are used by network switch/router 500 to send and receive data packets. Each I/O module 506(1)-506(N) can also include one or more packet processors 512(1)-512(N). Packet processors 512(1)-512(N) are hardware processing components (e.g., FPGAs or ASICs) that can make wire speed decisions on how to handle incoming or outgoing data packets.

It should be appreciated that network switch/router 500 is illustrative and not intended to limit embodiments of the present disclosure. Many other configurations having more or fewer components than network switch/router 500 are possible.

### 5. Computer System

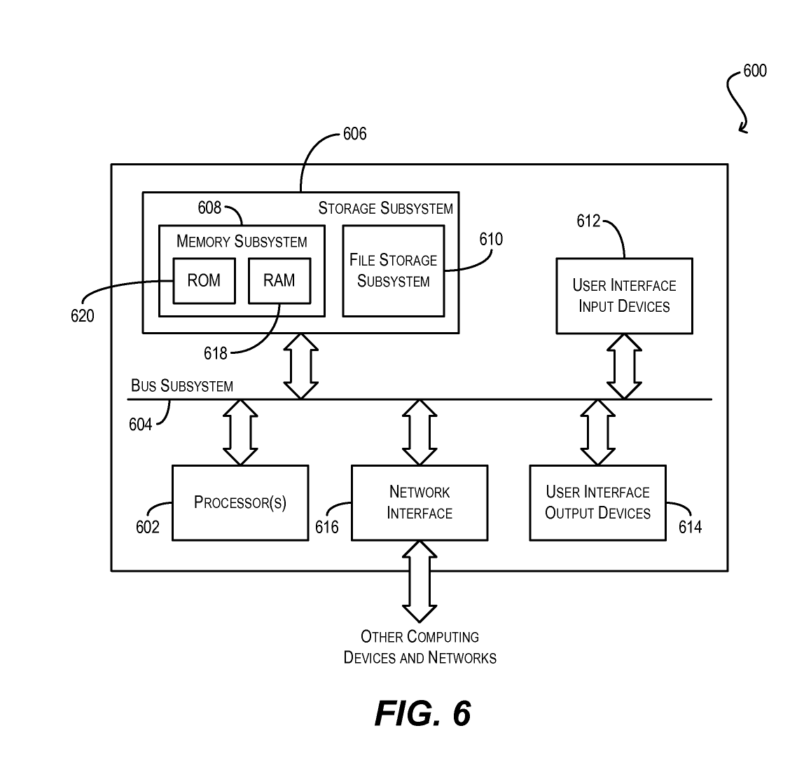

FIG. 6 depicts an example computer system 600 according to an embodiment. Computer system 600 may be used to implement, e.g., SDN controller 110 and/or a virtual version of network device 102 according to an embodiment.

As shown in FIG. 6, computer system 600 can include one or more processors 602 that communicate with a number of peripheral devices via a bus subsystem 604. These peripheral devices can include a storage subsystem 606 (comprising a memory subsystem 608 and a file storage subsystem 610), user interface input devices 612, user interface output devices 614, and a network interface subsystem 616.

Bus subsystem 604 can provide a mechanism for letting the various components and subsystems of computer system 600 communicate with each other as intended. Although bus subsystem 604 is shown schematically as a single bus, alternative embodiments of the bus subsystem can utilize multiple buses.

Network interface subsystem 616 can serve as an interface for communicating data between computer system 600 and other computing devices or networks. Embodiments of network interface subsystem 616 can include wired (e.g., coaxial, twisted pair, or fiber optic Ethernet) and/or wireless (e.g., Wi-Fi, cellular, Bluetooth, etc.) interfaces.

User interface input devices 612 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 600.

User interface output devices 614 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 600.

Storage subsystem 606 can include a memory subsystem 608 and a file/disk storage subsystem 610. Subsystems 608 and 610 represent non-transitory computer-readable storage media that can store program code and/or data that provide the functionality of various embodiments described herein.

Memory subsystem 608 can include a number of memories including a main random access memory (RAM) 618 for storage of instructions and data during program execution and a read-only memory (ROM) 620 in which fixed instructions are stored. File storage subsystem 610 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 600 is illustrative and not intended to limit embodiments of the present disclosure. Many other configurations having more or fewer components than computer system 600 are possible.

The above description illustrates various embodiments of the present disclosure along with examples of how certain aspects may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
receiving, by a computer system, minoring configuration information from an agent, the mirroring configuration information including one or more parameters specifying a flow to be mirrored by an in-band network device of a network and one or more parameters specifying a minor port of the in-band network device;
generating, by the computer system, a mirroring command based on the mirroring configuration information, the mirroring command including a rule indicating the in-band network device should minor the flow to the mirror port concurrently with Layer 2 or 3 forwarding of the flow within the network; and
transmitting, by the computer system, the mirroring command to the in-band network device.

2. The method of claim 1 wherein the mirroring command is formatted according to a software defined networking (SDN) protocol understood by the in-band network device.

3. The method of claim 2 wherein, upon receiving the mirroring command, the in-band network device is operable to program one or more entries in an SDN flow table based on the parameters and the rule.

4. The method of claim 3 further comprising, by the in-band network device:
receiving a data packet on an ingress port;
attempting to match the data packet against entries in the SDN flow table;
if a match is made with an entry in the SDN flow table, sending a copy of the data packet to the mirror port; and
forwarding the packet through the in-band network device's Layer 2 or 3 forwarding pipeline.

5. The method of claim 1 wherein the one or more parameters specifying the flow to be mirrored includes a source IP address, a destination IP address, a source port, a destination port, and a Layer 4 protocol.

6. The method of claim 1 wherein the mirror port of the in-band network device is connected to a traffic analytics tool.

7. The method of claim 6 wherein the traffic analytics tool is local to the network that includes the in-band network device.

8. The method of claim 6 wherein the traffic analytics tool resides in a separate, remote network.

9. The method of claim 8 wherein the mirror port identifies a logical tunnel interface of the in-band network device.

10. The method of claim 8 wherein the mirroring configuration information further includes one or more additional parameters for dynamically creating a tunnel to the traffic analytics tool on the in-band network device.

11. The method of claim 6 wherein the computer system is an SDN controller, and wherein the receiving, generating, and transmitting are performed by an SDN application running on the SDN controller.

12. The method of claim 11 wherein the agent is a user, and wherein the minoring configuration information is received from the user via a user interface made available by the SDN application.

13. The method of claim 11 wherein the agent is another software application, and wherein the mirroring configuration information is received from said another software application via one or more application programming interfaces (APIs) exposed by the SDN application.

14. The method of claim 13 wherein said another software application is a traffic analytics application that is in communication with the traffic analytics tool.

15. The method of claim 1 wherein one or more ingress ports of the in-band network device support a hybrid mode that enables incoming traffic on the one or more ingress Layer 2 or 3 forwarding tables.

16. A non-transitory computer readable storage medium having stored thereon program code executable by a computer system, the program code causing the computer system to:
receive mirroring configuration information from an agent, the minoring configuration information including one or more parameters specifying a flow to be mirrored by an in-band network device of a network and one or more parameters specifying a minor port of the in-band network device;
generate a minoring command based on the mirroring configuration information, the mirroring command including a rule indicating the in-band network device should mirror the flow to the minor port concurrently with Layer 2 or 3 forwarding of the flow within the network; and
transmit the minoring command to the in-band network device.

17. A computer system comprising:
a processor; and
a non-transitory computer readable medium having stored thereon program code that, when executed by the processor, causes the processor to:
receive mirroring configuration information from an agent, the minoring configuration information including one or more parameters specifying a flow to be mirrored by an in-band network device of a network and one or more parameters specifying a minor port of the in-band network device;
generate a minoring command based on the mirroring configuration information, the mirroring command including a rule indicating the in-band network device should minor the flow to the mirror port concurrently with Layer 2 or 3 forwarding of the flow within the network; and
transmit the minoring command to the in-band network device.

18. A method comprising:
receiving, by a network device, a mirroring command from a computer system, the network device being operable for forwarding data plane traffic within a network, the minoring command including:
one or more parameters specifying a flow to be mirrored by the network device;
one or more parameters specifying a minor port of the network device; and
a rule indicating the network device should mirror the flow to the mirror port concurrently with Layer 2 or 3 forwarding of the flow within the network; and
programming, by the network device, an entry into a software defined networking (SDN) flow table of the network device in accordance with the minoring command.

19. A non-transitory computer readable storage medium having stored thereon program code executable by a network device that is operable for forwarding data plane traffic within a network, the program code causing the network device to:
receive a minoring command from a computer system, the mirroring command including:
one or more parameters specifying a flow to be mirrored by the network device;
one or more parameters specifying a minor port of the network device; and
a rule indicating the network device should mirror the flow to the mirror port concurrently with Layer 2 or 3 forwarding of the flow within the network; and
program an entry into a software defined networking (SDN) flow table of the network device in accordance with the mirroring command.

20. A network device operable for forwarding data plane traffic within a network, the network device comprising:
a processor; and
a non-transitory computer readable medium having stored thereon program code that, when executed by the processor, causes the processor to:
receive a minoring command from a computer system, the mirroring command including:
one or more parameters specifying a flow to be mirrored by the network device;
one or more parameters specifying a minor port of the network device; and
a rule indicating the network device should mirror the flow to the minor port concurrently with Layer 2 or 3 forwarding of the flow within the network; and
program an entry into a software defined networking (SDN) flow table of the network device in accordance with the mirroring command.
